(19) United States
(12) Patent Application Publication
(10) Pub. No.: US 2026/0284457 A1
(43) Pub. Date: Sep. 24, 2026

(54) FIRE EXTINGUISHING METHOD AND FIRE EXTINGUISHING FACILITY

(71) Applicant: YAMATO PROTEC CORPORATION, Tokyo (JP)

(72) Inventors: Akimitsu Kikkawa, Tokyo (JP); Tatsuki Endo, Tokyo (JP)

(73) Assignee: YAMATO PROTEC CORPORATION, Tokyo (JP)

(21) Appl. No.: 19/476,373

(22) PCT Filed: Apr. 1, 2024
(86) PCT No.: PCT/JP2024/013508

§ 371 Date: Oct. 17, 2025

(30) Foreign Application Priority Data
Apr. 18, 2023 (JP) 2023-067824

(51) Int. Cl. A62C 99/00

(52) U.S. Cl. CPC A62C 99/0018

(57) ABSTRACT

The present invention provides a novel fire extinguishing method and a fire extinguishing system using an aerosol fire extinguishing composition. The fire extinguishing method of the present invention is characterized in that an aerosol fire extinguishing gas containing a potassium compound is discharged into a target space to set a spatial concentration of potassium in the target space to 1.2 ppm or more. The fire extinguishing system of the present invention is characterized in that it includes a discharge device that discharges an aerosol fire extinguishing gas containing a potassium compound into a target space so that a spatial concentration of potassium becomes 1.2 ppm or more.

### TECHNICAL FIELD

The present invention relates to a fire extinguishing method using an aerosol fire extinguishing composition, and a fire extinguishing system.

### PRIOR ARTS

The present applicant has developed a novel aerosol fire extinguishing composition that functions as a fire extinguishing agent by generating smoke having fire extinguishing performances through a thermal reaction with a potassium compound (for example, Patent Literature 1: Japanese Patent No. 6443882). However, there is still room for further study as to what conditions are preferable for using such an aerosol fire-extinguishing composition when it is made to function as a fire-extinguishing agent.

### CITATION LIST

### Patent Literature

Patent Literature 1: Japanese Patent No. 6443882

### SUMMARY OF INVENTION

### Problem to be Solved

Therefore, an object of the present invention is to provide a novel fire extinguishing method using an aerosol fire extinguishing composition, and a fire extinguishing system.

### Means to Solve the Problem

In order to solve the above-mentioned problems, the present invention provides a fire extinguishing method, comprising:
discharging an aerosol fire extinguishing gas containing a potassium compound into a target space to set a spatial concentration of potassium in the target space to 1.2 ppm or more.

Further, in the fire extinguishing method of the present invention, it is preferable that an amount of an aerosol fire extinguishing agent that generates the aerosol fire extinguishing gas is determined so as to satisfy the following equation:

$$C [ ppm ] = β \cdot W [ g / {m}^{3} ]$$

where C is potassium ion concentration [ppm], W is the amount of extinguishing agent [g/m³] and β is potassium ion generation coefficient [−].

The present invention also provides a fire extinguishing system, characterized by;
including a discharge device that discharges an aerosol fire extinguishing gas containing a potassium compound into a target space so that a spatial concentration of potassium becomes 1.2 ppm or more.

### Effects of the Invention

According to the present invention, it is possible to provide a novel fire extinguishing method using the aerosol fire extinguishing composition and fire extinguishing system.

### BRIEF DESCRIPTION OF THE DRAWINGS

FIG. 1 is a diagram showing examples of the appearance of the aerosol fire extinguishing agent 10 which are processed in a solid form and a sheet form.

FIG. 2 is a diagram showing an example of a basic configuration of the aerosol gas discharge device 4.

FIG. 3 is a diagram showing an example of a basic configuration of the aerosol fire extinguishing system 1.

FIG. 4 is a diagram showing an example of operation flow of the aerosol fire extinguishing system 1.

FIG. 5 is a graph showing the flame extinguishing limit of n-heptane.

FIG. 6 is a graph showing the relationship between the potassium ion concentration and the amount of fire extinguishing agent.

FIG. 7 is a graph showing the relationship between the amount of the fire extinguishing agent of Type: B and the fire extinguishing time.

### EMBODIMENTS FOR ACHIEVING THE INVENTION

Hereinafter, representative embodiments of the fire extinguishing method and the fire extinguishing system according to the present invention will be described in detail below with reference to the drawings. However, the present invention is not limited to these drawings. Further, since the drawings are intended to conceptually explain the present invention, the dimensions, ratios, or numbers may be exaggerated or simplified in order to facilitate easy understanding.

### 1. With Respect to Fire Extinguishing by Aerosols

Generally, an aerosol is defined as a mixture in which fine solid or liquid particles are dispersed in a continuous phase gas (which may contain partially discontinuous phases). The aerosol with fire extinguishing properties can be obtained by subjecting aerosol fire extinguishing agent to a chemical reaction caused by heat. The aerosol fire extinguishing gas has the property of flowing along with the gas flow, since solid particles are dispersed in the reaction product gas. Therefore, the aerosol fire extinguishing gas can be treated as gas extinguishing agents in the same way as gases (such as carbon dioxide) used in general firefighting.

The aerosol fire extinguishing agent that generates the aerosol fire extinguishing gas is a solid material that contains a potassium compound as the main component. Though the details of such fire extinguishing agent will be described later, the fire extinguishing agent is solid when stored, and when a certain amount of heat is applied, the agent undergoes a chemical reaction (for example, thermal decomposition) to release an aerosol as the reaction product. The released aerosol is a mixture of the reaction product gas and fine particles in the form of white smoke, and acts as a fire extinguishing gas. The fire extinguishing properties of the aerosol fire extinguishing gas are obtained by that the potassium contained in the fine particles extinguishes the chemical reactions in the flame through a negative catalytic effect.

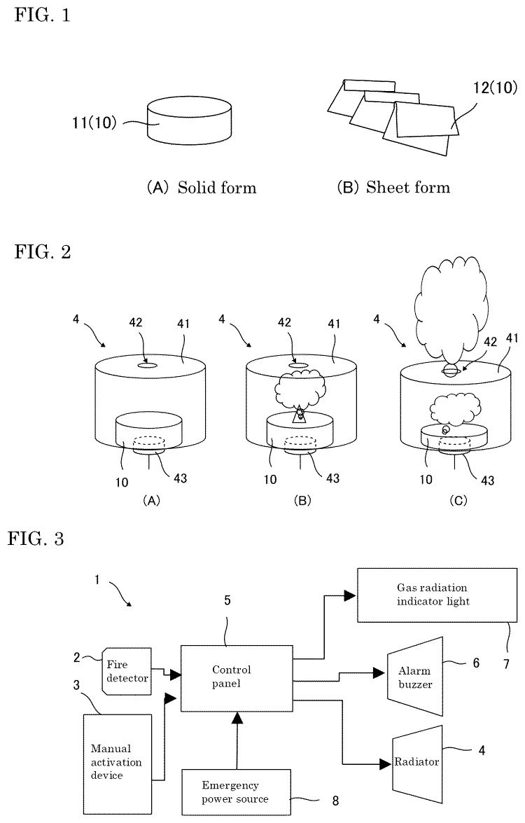

Although the aerosol fire extinguishing agent is solid, it is possible to mold into any size and shape using solvents, dispersants, and binders as necessary. That is, even after molding, the aerosol fire extinguishing agent still has such a fire extinguishing function. For example, as exemplified in FIGS. 1(A) and (B), it is possible to mold an aerosol fire extinguishing agent 10 into a solid (e.g., cylindrical or fan-shaped) agent 11 or into a flexible or foldable sheet-shaped agent 12.

The aerosol extinguishing gas contains a reaction product gas and fine particles that have the effect of extinguishing a flame. The fine particles that have the main fire extinguishing properties have a particle size of not more than 1 μm and are mainly composed of a white potassium compound. Therefore, when the released aerosol fire extinguishing gas is viewed, it appears as if white smoke is being emitted.

The aerosol fire extinguishing agent 10 (e.g., the agent 12) molded into a sheet shape can exhibit its fire extinguishing properties by itself when placed adjacent to and in close contact with an object where fire ignition is anticipated. For example, when a sheet-shaped agent 12 is attached to the inside or outside of a lithium-ion battery or inside a container that houses the lithium-ion battery, the fire extinguishing agent thermally reacts at the temperature of the flame at the time of ignition and releases the aerosol fire extinguishing gas.

Alternatively, when cannot being placed adjacent to and in close contact with the object where fire ignition is anticipated, it is necessary to have the function to forcibly release and discharge the aerosol fire extinguishing gas to the source of the fire, or to fill the entire room where a fire is anticipated with the aerosol fire extinguishing gas. Such applications include server rooms, electrical rooms, electric generator rooms, multistorey parking garages, and the like.

An apparatus used for this application includes an aerosol gas discharge device 4, which contains the solid aerosol fire extinguishing agent 10 (e.g., the agent 11) in a storage box 41, and upon receiving a fire detection signal, forces the fire extinguishing agent 10 to undergo the thermal reaction to emit the aerosol fire extinguishing gas from a discharge opening 42 (see, for example, (A) to (C) of FIG. 2).

The aerosol gas discharge device 4 shown in FIG. 2 has a simple structure in which an initiation component 43 for electrically initiating a thermal reaction of the solid aerosol fire extinguishing agent 10 is attached and the aerosol gas discharge device is stored in a storage box 41 having the discharge opening 42. The discharge pressure required for discharging the aerosol fire extinguishing gas can be obtained by appropriately adjusting the reaction rate of the fire extinguishing agent 10 and the opening area of the discharge opening 42. That is, it can be said that the aerosol fire extinguishing agent 10 incorporates a pressurizing gas source for obtaining discharge power.

### 2. With Respect to Aerosol Fire Extinguishing System

When the discharge device is used in the gas fire extinguishing system for firefighting, it is preferable that the system functions so as to automatically extinguish the fire from the detection of the fire. As an example of such the aerosol fire extinguishing system that functions in this manner, FIG. 3 shows the basic configuration of the aerosol fire extinguishing system 1 made up of a series of devices.

The aerosol fire extinguishing system 1 shown in FIG. 3 includes equipment such as a fire detector 2 that is installed in a room where a fire is anticipated and detects the fire, a manual activation device 3 that is activated manually when a person discovers the fire, a control panel 5 that receives a signal from the fire detector 2 and sends an activation electrical signal to the aerosol gas discharge device 4, an alarm buzzer 6 that guides people to evacuate, a gas radiation indicator light 7 that shows when the extinguishing gas is full, and an emergency power source 8.

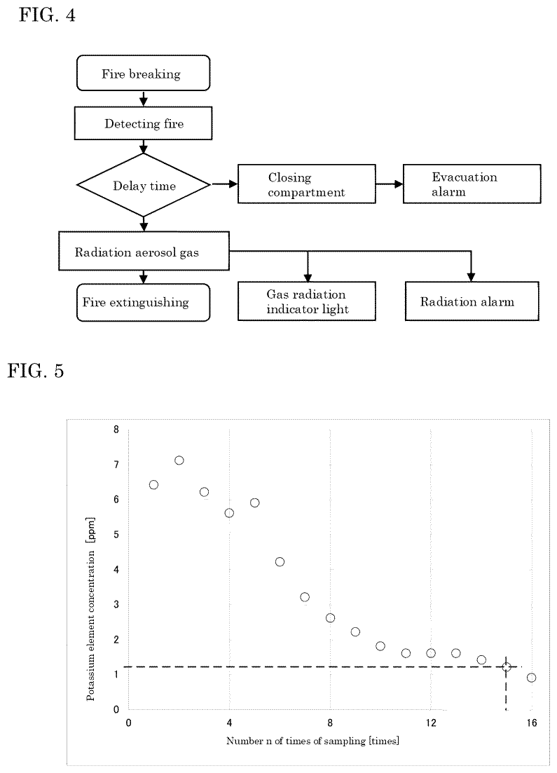

As an example of the operation flow of the aerosol gas fire extinguishing system 1, FIG. 4 shows an example designed as a full-area discharge method. In the aerosol gas fire extinguishing system 1, a fire is detected by the fire detector 2 or a person, the detected fire signal is received by the control panel 5, and an evacuation alarm is issued to evacuate people within the fire compartment, and the compartment is closed. Then, after a certain delay time has elapsed, the aerosol gas discharge device 4 is activated, and at the same time the gas radiation indicator light 7 installed at the entrance to the compartment is turned on, and the aerosol gas fills the compartment and the fire is extinguished.

### 3. With Respect to Aerosol Fire Extinguishing Agent

Here, the aerosol fire extinguishing agent is explained, including the basic extinguishing principles.

The main components of the aerosol fire extinguishing agent are an organic potassium compound and an inorganic potassium compound, which undergo a thermal reaction at a temperature of about 200 to 300° C. and discharge reaction products.

### 3-1. Composition of Fire Extinguishing Agent

The aerosol fire extinguishing agent preferably contains 20 to 50% by mass of a fuel (component A) and 80 to 50% by mass of a chlorate (component B), and further, contains 6 to 1000 parts by mass of a potassium salt (component C) with respect to 100 parts by mass of the total amount of the fuel and the chlorate, and has a thermal decomposition initiation temperature in the range of higher than 90° C. to 260° C.

The fuel as the component A is a component for generating thermal energy by combustion together with the chlorate as the component B to generate an aerosol (potassium radical) derived from the potassium salt of the component C.

As the fuel for the component A, preferable is, for example, at least one selected from the group consisting of dicyandiamide, nitroguanidine, guanidine nitrate, urea, melamine, melamine cyanurate, Avicel, guar gum, sodium carboxymethylcellulose, potassium carboxymethylcellulose, ammonium carboxymethylcellulose, nitrocellulose, aluminum, boron, magnesium, magnalium, zirconium, titanium, titanium hydride, tungsten, and silicon.

The chlorate of the component B is a strong oxidizing agent, and is a component for generating thermal energy by combustion together with the fuel of component A and generating an aerosol (potassium radical) derived from the potassium salt of component C.

As the chlorate of the component B, preferable is, for example, at least one selected from potassium chlorate, sodium chlorate, strontium chlorate, ammonium chlorate and magnesium chlorate.

Here, the content ratio of the fuel of the component A and the chlorate of the component B in the total 100% by mass is as follows:
Component A: 20 to 50% by mass, preferably 25 to 40% by mass, more preferably 25 to 35% by mass,
Component B: 80 to 50% by mass, preferably 75 to 60% by mass, more preferably 75 to 65% by mass.

Next, the potassium salt of the component C is a component for generating the aerosol (potassium radical) by the thermal energy generated by the combustion of the component A and the component B.

As the potassium salt of the component C, preferable is, for example, at least one selected from potassium acetate, potassium propionate, monopotassium citrate, dipotassium citrate, tripotassium citrate, monopotassium trihydrogen ethylenediaminetetraacetate, dipotassium dihydrogen ethylenediaminetetraacetate, tripotassium monohydrogen ethylenediaminetetraacetate, tetrapotassium ethylenediaminetetraacetate, potassium hydrogen phthalate, dipotassium phthalate, potassium hydrogen oxalate, dipotassium oxalate, and potassium bicarbonate.

The content ratio of the component C is preferably 6 to 1000 parts by mass, and more preferably 10 to 900 parts by mass, particularly preferably 10 to 100 parts by mass with respect to 100 parts by mass of the total amount of the component A and the component B.

Furthermore, the fire extinguishing agent has a thermal decomposition initiation temperature in the range of more than 90° C. to 260° C., preferably more than 150° C. to 260° C. Such a range of the thermal decomposition initiation temperature can be adjusted by combining the above-mentioned components A, the component B and the component C in the above-mentioned ratio.

When the extinguishing agent satisfying the above-mentioned range of the thermal decomposition initiation temperature, the components A and the component B are automatically ignited and burned by the heat at the time of the outbreak of a fire, and the aerosol (potassium radical) derived from the component C is generated, thereby making it possible to extinguish the fire without using an ignition device or the like. However, the use of ignition device or the like would not be excluded.

Note that, the ignition temperature of wood, which is a common combustible material found indoors, is 260° C., by setting the thermal decomposition initiation temperature at a temperature below 70° C., which is the general operating temperature of the heat detector of an automatic fire alarm system installed in places where open flames are handled, the fire can be extinguished quickly and the malfunction of the heat detector can be prevented. In particular, since the maximum set temperature of the heat detector is 150° C., by setting the lower limit of the thermal decomposition initiation temperature to more than 150° C., it is possible to obtain high availability suitable for use in buildings such as houses and building materials.

The form of the fire extinguishing agent is not particularly limited, and it is possible to use as a liquid such as a dispersion, or as a solid such as a powder or a molded product of a desired shape. When being the dispersion, it is possible to also use as a coating agent by discharging. Further, the molded product can be formed into the shape of granules, pellets of a desired shape (cylindrical or the like), tablets, spheres, disks, or the like, and it is preferable to have an apparent density of 1.0 g/cm³ or more.

Note that, when the fire extinguishing agent is formed into the sheet, a binder and other components may be added to the components of the above-mentioned fire extinguishing agent. As the binder and other components, various materials can be used as long as they are capable of molding the fire extinguishing agent without impairing its function, and particularly, the binder may be either an inorganic binder or an organic binder. Note that, it is possible to prepare the self-extinguishing molded article of the present invention without using a binder, when using a dispersing agent described below.

### 3-2. Thermal Reaction of Fire Extinguishing Agent

In the fire extinguishing agent, there are two patterns, one being that when starting the thermal reaction in just one part of the agent, the reaction automatically undergoes in the manner of chain reaction and then the entire aerosol fire extinguishing agent reacts, and another being that the reaction undergoes only at the part where heat is applied. In both cases, the reaction product is an aerosol-like fire extinguishing gas which is composed of gas components such as carbon dioxide gas and floating potassium compound particles, and when coming into contact with a fire flame, the potassium is released and becomes a potassium radical (hereafter referred to as K radical) within the flame to exhibit extinguishing effects and function as a fire extinguishing agent.

The main reaction schemes of K radicals in the flame reactions are as shown in the following chemical schemes (1) to (6), and the flame is extinguished by reacting K radicals with OH radical or H radical in the KOH cycle.

The chemical schemes for the negative catalytic reaction of this K radical are as follows:

K·+·OH→KOH (1)

KOH+·H→K·+H₂O (2)

KOH+·OH→KO·+H₂O (3)

KO·+·H→K·+OH (4)

KO·+·O→K·+O₂ (5)

KO·+·OH→K·+HO₂ (6)

Therefore, the fire extinguishing principle of the flame is based on the negative catalytic effect, similar to that of common potassium-based powder fire extinguishing agents.

### 3-3. Evaluation of Fire Extinguishing Performance

The fire extinguishing performance of the aerosol fire extinguishing is determined by the amount of aerosol fire extinguishing gas and the amount of potassium contained therein according to the principle of the fire extinguishing. Based on the fact that the fire extinguishing principle of the aerosol fire extinguishing gas is flame extinguishing due to the negative catalytic effect of K radicals, the inventors evaluated the fire extinguishing performance of the aerosol fire extinguishing gas by focusing on the amount of potassium required for flame extinguishing.

Though the amount of the fire extinguishing agent actually required for extinguishing a flame varies depending on the combustible material, here, n-heptane, which is the standard combustible material used in the field of firefighting, was used as the standard combustible material (i.e., the material to be extinguished). Further, since the amount of the agent sufficient for extinguishing a flame depends on the amount of the potassium contained in the aerosol fire extinguishing gas, the aerosol fire extinguishing gas was sampled, and the amount of potassium ions dissolved in a certain amount of water was converted into a ratio, and the potassium ion concentration [ppm] was used as an index.

Specifically, after filling a certain test container (a standard container or a target space) with a sufficient amount of the aerosol fire extinguishing gas, the atmosphere inside the container was collected with a syringe. That is, 5 mL of distilled water was filled into the syringe, and 50 mL of the atmosphere was collected. The collected atmosphere was thoroughly mixed with distilled water to dissolve the particles contained in the aerosol fire extinguishing gas into the distilled water. The potassium ion concentration in the aqueous solution was then measured, and the concentration of potassium element in the atmosphere was estimated.

The potassium ion concentration was measured using the following measuring apparatuses.
Measuring apparatus: LAQUAtwin-K-11 (available from Horiba Advanced Techno Co., Ltd.)
Measurement principle: Ion electrode method

The limit concentration at which the flame is extinguished (hereinafter also referred to as the “flame-extinguishing concentration”) was determined under the condition that a fire pan of n-heptane placed in a standard container ignites. Starting from an initial value of 6.5 ppm, the measurements were carried out 16 times, and the results are shown in FIG. 5. No ignition occurred until the 15th measurement, but ignition occurred at the 16th measurement, so the potassium ion concentration at the 15th measurement, 1.2 ppm, was determined to be the flame-extinguishing limit for n-heptane. The (inside of) the above-mentioned standard container can be said to be a simulation of a target space into which the aerosol fire extinguishing gas of the present invention is discharged for extinguishing the fire, and it is preferable to discharge the aerosol fire extinguishing gas containing the potassium compound into the above-mentioned standard container (target space) so that the spatial concentration of potassium in the above-mentioned standard container becomes 1.2 ppm or more. Note that, although there is no theoretical upper limit to the spatial concentration of potassium, actually, the upper limit can be considered to be 170 ppm.

Next, the relationship between the potassium ion concentration and the aerosol fire extinguishing agent was confirmed.

In the aerosol fire extinguishing agent, the amount of the potassium generated varies depending on the composition ratio of the agent. Therefore, the following typical conditions were examined using drugs Type: A and Type: B.

Type: A Fire extinguishing agent of a type in which a chain of thermal reactions continues with heating in one location.

It has the property of releasing a large amount of the aerosol fire extinguishing gas in a short period of time.

Type: B: Fire extinguishing agent of a type in which the agent undergoes thermal reaction slowly only in the heated area.

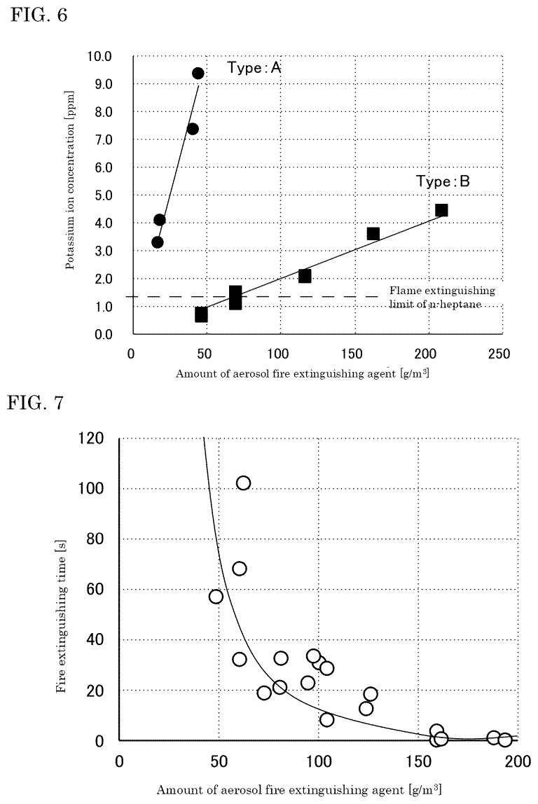

The results are shown in FIG. 6.

From the figure, the following equation was obtained as the relationship between the potassium ion concentration and the amount of the aerosol fire extinguishing agent.

$$C [ ppm ] = β \cdot W [ g / {m}^{3} ] \qquad ( 1 )$$

where, C: Potassium ion concentration [ppm]
   W: Amount of fire extinguishing agent [g/m³]
   β: Potassium ion generation coefficient [−]
Type: A Ba: Potassium ion generation coefficient (A=0.2 [−])
Type: B Bb: Potassium ion generation coefficient (B=0.02 [−])

From the equation (1), it is possible to determine the amount of the aerosol fire extinguishing agent required to extinguish the flame of the combustible substance n-heptane. Further, even if the flammable material changes, the amount of the aerosol fire extinguishing agent can be determined from the potassium ion concentration by measuring the flame extinguishing limit, which provides a minimum design standard. However, when the fire to be extinguished is in a large space or when multiple combustible materials are expected to be present at the same time, it is preferable to take these conditions into consideration.

That is, when the space is large, it is advisable to design by adding a safety factor taking into account the placement conditions of the aerosol gas discharge devices, the difference in concentration distribution of the aerosol fire extinguishing gas at the farthest point when multiple discharge devices are activated simultaneously, the delay time due to the shields, and the outflow losses at openings, and the like. Further, when multiple combustible materials are included, it is advisable to design using the flame extinguishing limit having the highest potassium ion concentration as the design standard.

Furthermore, attention should be paid to the setting of time to extinguish the fire and the extinguishing time. When extinguishing the fire using the aerosol fire extinguishing agent in an amount sufficient to generate a sufficient potassium ion concentration, the diffusion time of the aerosol fire extinguishing gas and the fire extinguishing time are generally the same, but at concentrations near the limit concentration of flame extinguishing, a delay occurs in extinguishing the fire. FIG. 7 shows the relationship between the amount of fire extinguishing agent and the fire extinguishing time for the fire extinguishing agent of Type: B.

### 3-4. Method for Determining the Amount of Agent

From the above, the amount of the aerosol fire extinguishing agent can be determined as follows.
(a) The limit of flame extinguishing of the potassium element concentration C in the aerosol fire extinguishing gas is assumed to be the concentration of flame extinguishing C_{T}[g/m³], and the corresponding amount of the flame extinguishing agent W_{T}[g/m³] is calculated.

From the results of the previous experiments, it is preferable that the extinction concentration C_{T}[g/m³] is set to a value of 1.2 ppm or more. That is, in the fire extinguishing method and fire extinguishing system according to the present invention, it is preferable that the aerosol fire extinguishing gas containing the potassium compound is discharged into the target space to adjust so that the spatial concentration of potassium in the target space is set to 1.2 ppm or more. The amount W_{T}[g/m³] of the flame extinguishing agent is obtained from the above-mentioned expression (1).
(b) From the relationship between the amount of the fire extinguishing agent and the fire extinguishing time, the amount W_{O}[g/m³] of the fire extinguishing agent that results in a fire extinguishing time of 60 seconds or less is determined. (Amount W_{O} of fire extinguishing agent=A value).

For example, with respect to the combustion of n-heptane, it is possible to determine the appropriate amount W_{O}[g/m³], i.e., A value of the fire extinguishing agent, from the following equation (2), which is obtained by varying the amount W of the fire extinguishing agent which is released into a certain space and by measuring the extinguishing time.

$$1 / T [ {s}^{- 1} ] = γ \cdot W [ g / {m}^{3} ] - δ [ {s}^{- 1} ] \qquad ( 2 )$$

where, 1/T: Reciprocal of fire extinguishing time [s⁻¹]
   W: Amount of the fire extinguishing agent [g/m³]
   γ: Extinguishing coefficient=0.0007 [m³·s⁻¹/g]
   δ: Coefficient representing the extinguishing limit concentration=0.0162 [s⁻¹]
(c) From a normalized graph of the time-dependent change in the potassium element concentration C [g/m³] in the aerosol fire extinguishing gas, the limit agent amount W₁ [g/m³] is determined taking into account the flare-up prevention time (limit agent amount W₁=B value).

In order to confirm the conditions under which the potassium element concentration in the discharged aerosol fire extinguishing gas remains equal to or more than the flame extinguishing concentration C_{T} after the flame has been extinguished, the time-dependent change in potassium element concentration in the space after the aerosol fire extinguishing gas has been discharged is measured. That is, the aerosol fire extinguishing gas is generated from the fire extinguishing agent within a fixed volume space, a fixed amount of the gas is quantitatively sampled at a regular time intervals, and dissolved in water, and thereafter the potassium ion concentration in the aqueous solution is measured.

Next, the potassium element concentration in the space is then estimated from the potassium ion concentration.

Then, the normalization is performed using the potassium element concentration C₀ immediately after the discharge, and the equation (3) between the normalized potassium element concentration y and time t is obtained as in followings.

$$y = - α \cdot t + 1 \qquad ( 3 )$$

where, y: Normalized potassium element concentration [−]
   t: Time [min]
   α: Coefficient

Here, it is possible to incorporate the design conditions that take into account the flare-up. The flare-up prevention time is selected as the longer of the time when the combustible material has dropped to a temperature that does not flare-up (e.g., 15 minutes) or the time when the fire department rushes to the scene (e.g., 20 minutes) (here 20 minutes).

In order to maintain the flame extinguishing concentration C_{T} for 20 minutes, the potassium element concentration (initial concentration) C₀ of the aerosol fire extinguishing gas required at the initial value t=0 is calculated using the following equation (4).

$${C}_{0} = {C}_{r} / y \qquad ( 4 )$$

where, C₀: Initial concentration, potassium element concentration [g/m³]
   C_{T}: Flame extinguishing concentration, potassium element concentration C_{T}=1.2 [g/m³]
   y: Normalized potassium element concentration [−]

Therefore, from the equation (1), the amount W_{T}[g/m³] of the flame extinguishing agent, i.e., the B value, can be determined.
(d) Select from the A value and B value depending on the object to be extinguished, and determine the agent amount of standard design W_{S}[g/m³] of the fire extinguishing agent.
(e) Multiply the agent amount of standard design W_{S}[g/m³] by the safety factor X to calculate the designed agent amount WS [g/m³].

Thereby, the designed agent amount WS is obtained.

Representative embodiments of the present invention have been described above, but the present invention is not limited thereto, and various design modifications are possible, which are also included in the present invention.

For example, the present invention also relates to a fire extinguishing system, characterized by including a discharge device that discharges an aerosol fire extinguishing gas containing a potassium compound into a target space so that a spatial concentration of potassium is 1.2 ppm or more. It is preferable that the fire extinguishing system is equipped with a sensor for measuring the spatial concentration of potassium.

The sensor may be configured, for example, to mix a predetermined amount of the aerosol fire extinguishing gas that has filled a predetermined space (target space) with a predetermined amount of distilled water to obtain a mixed aqueous solution, and to measure the potassium ion concentration in the mixed aqueous solution using an ion electrode method.

EXPLANATION OF SYMBOLS

| | |
|---|---|
| 1 | Aerosol fire extinguishing system |
| 2 | Fire detector |
| 3 | Manual activation device |
| 4 | Aerosol gas discharge device |
| 5 | Control panel |
| 6 | Alarm buzzer |
| 7 | Gas radiation indicator light |
| 8 | Emergency power source |
| 10, 11, 12 | Aerosol fire extinguishing agent |

1. A fire extinguishing method, comprising:
discharging an aerosol fire extinguishing gas containing a potassium compound into a target space to set a spatial concentration of potassium in the target space to 1.2 ppm or more.

2. The fire extinguishing method according to claim 1, wherein:
an amount of an aerosol fire extinguishing agent that generates the aerosol fire extinguishing gas is determined so as to satisfy the following equation:
$$C [ ppm ] = β \cdot W [ g / {m}^{3} ]$$
where C is potassium ion concentration [ppm], W is the amount of extinguishing agent [g/m³] and β is potassium ion generation coefficient [−].

3. A fire extinguishing system, characterized by including a discharge device that discharges an aerosol fire extinguishing gas containing a potassium compound into a target space so that a spatial concentration of potassium is 1.2 ppm or more.
